(19) United States
(12) Patent Application Publication
(10) Pub. No.: US 2004/0175318 A1
(43) Pub. Date: Sep. 9, 2004

(54) Method and apparatus for oxidizing carbon monoxide

(75) Inventors: Noboru Segawa, Kanagawa-ken (JP); Kuniyuki Araki, Saitama-ken (JP)

Correspondence Address: FOLEY AND LARDNER, SUITE 500, 3000 K STREET NW, WASHINGTON, DC, 20007, US

(73) Assignee: KABUSHIKI KAISHA TOSHIBA

(21) Appl. No.: 10/796,201

(22) Filed: Mar. 10, 2004

(30) Foreign Application Priority Data
Sep. 13, 2002 (JP) 2002-269136

(51) Int. Cl. B01D 53/62; B01J 19/08

(52) U.S. Cl. 423/247; 422/186.07; 204/176

(57) ABSTRACT

An odor component in an air is deodorized by an ozone generating member in an ozone an ozone generating area formed in a path through which the air flows, the generated ozone is decomposed by an ozone decomposing member in an ozone decomposing area, and a carbon monoxide, generated in, for example, through incomplete combustion, a CO adsorbing area in the path is adsorbed and carried by a CO adsorbing member. The ozone decomposing area and the CO adsorbing area are formed in a common oxidizing reaction area in which the carbon monoxide is oxidized by using active oxygen generated through the ozone decomposing step in the oxidizing reaction area.

### BACKGROUND OF THE INVENTION

1. Field of the Invention

The present invention relates to a method and apparatus for oxidizing carbon monoxide applicable to an air cleaner, a smoke separator, a deodorizing equipment, an air conditioner, or the like, particularly, in which carbon monoxide can be oxidized and eliminated at an ordinary (i.e., room) temperature or concentration thereof can be effectively reduced.

2. Related Art

In a known art, there is provided an air cleaner for improving living space or working space by effectively removing an odor component, drifting fungi or the like in the air for ensuring the comfortable life. This kind of an air cleaner is disclosed in Japanese Patent Laid-open (KOKAI) Publication Nos. HEI 5-317639 and HEI 10-85533.

The air cleaner disclosed therein comprises an ozone generator for generating ozone in a ventilation path and an ozone decomposer for decomposing the generated ozone for generating an active oxygen, which are provided successively, for decomposing the ozone generated by the ozone generator by utilizing an ozone decomposing catalyst provided in the ozone decomposer so as to generate oxygen atoms in nascent state, that is, so-called active oxygen (radical oxygen), to react the active oxygen with the odor component to thereby deodorize and purify the air.

According to the air cleaner utilizing the ozone, the odor component in the air, such as ammonia, hydrogen sulfide, acetaldehyde, formaldehyde, metal-rutile captan, trimethyl amine, ethylene, methyl disulfide, and styrene can be effectively removed or eliminated.

According to the conventional air cleaner, however, it is difficult to substantially eliminate carbon monoxide (CO or CO gas) which is generated through incomplete combustion in, for example, smoking of cigarettes. The CO is a physiologically extremely poisonous substance which is coupled with hemoglobin in a blood to paralyze or inhibit the internal organ function.

On the other hand, if the CO generated through the incomplete combustion is subjected to the oxidizing reaction with the active oxygen, since the CO is oxidized into carbon dioxide (CO₂), the extremely poisonous CO amount in the air can be effectively reduced or eliminated. However, the life of the active oxygen (radical oxygen) obtained through the decomposition of the ozone is of a 10⁻⁶ to 10⁻⁷ sec order, being extremely short.

Therefore, according to the conventional air cleaner, the ozone decomposer and a lower fatty acid adsorbing filer or an active carbon adsorbing filter, which is arranged on the downstream side of the ozone decomposer, are disposed separately, and any CO adsorber for adsorbing the carbon monoxide is not provided, so that it has been difficult to carry out an oxidizing reaction of the active oxygen generated by the ozone generator with the carbon monoxide.

Further, in the air cleaner disclosed in the Japanese Patent Laid-open Publication No. HEI 5-317639, since the CO adsorber is not provided, the active oxygen generated by the ozone generator is not usable for the oxidizing reaction of the carbon monoxide so that the CO in the air cannot be oxidized, and thus the CO amount cannot be reduced or eliminated.

Moreover, in the air cleaner disclosed in the Japanese Patent Laid-open Publication No. HEI 10-85533, the ozone decomposer and the active carbon absorbing filter are provided separately, and on the other hand, the ozone decomposer comprises two filters, i.e., first and second ozone decomposing filters. Although the first filter has a platinum catalyst adhering to a filter base material, since the platinum layer and the ozone decomposing layer are layers different from each other, the active oxygen is not efficiently contacted to the carbon monoxide to carry out the oxidizing reaction, and moreover, since the adsorbing filter is made of an active carbon, it is to be replaced frequently, thus being inconvenient for achieving a long time use.

### SUMMARY OF THE INVENTION

The present invention was conceived in consideration of the circumstances in the prior art mentioned above and an object of the present invention is therefore to provide a method and apparatus for oxidizing carbon monoxide, capable of effectively removing or eliminating an odor component and reducing a CO component through an oxidizing reaction of the CO in the air at an ordinary temperature.

Another object of the present invention is to provide a method and apparatus for oxidizing carbon monoxide, capable of realizing a long use life with a necessity of maintenance work being substantially eliminated without using any element to be changed for the oxidizing reaction of the carbon monoxide.

These and other objects can be achieved according to the present invention by providing, in one aspect, a method of oxidizing carbon monoxide in an air flowing in a structure forming a path comprising the steps of:

generating ozone for deodorizing an odor component in the air in an ozone generating area;

decomposing the generated ozone in an ozone decomposing area; and

adsorbing and carrying carbon monoxide generated through an incomplete combustion in a CO (carbon monoxide) adsorbing area;

wherein the ozone decomposing area and the CO adsorbing area are formed in a common oxidizing reaction area in which the carbon monoxide is oxidized by using active oxygen generated through the ozone decomposing step in the oxidizing reaction area.

In a preferred embodiment of this aspect, the ozone is generated, by a discharge type photocatalyst module, in the ozone generating area for eliminating the odor component and the ozone decomposing area for decomposing the ozone is formed in the CO adsorbing area for adsorbing the carbon monoxide.

In a modification of the above aspect, there is provided a method of oxidizing carbon monoxide in an air flowing through a ventilation path having a suction port and a discharge port, comprising the steps of:

generating an ozone in an ozone generating area for generating the ozone in the ventilation path;

deodorizing an odor component in the air by the ozone generated in the ozone generating area;

decomposing the generated ozone into active oxygen in an ozone decomposing area disposed on a downstream side of the ozone generating area in the ventilation path; and

adsorbing and carrying carbon monoxide generated through an incomplete combustion in a CO (carbon monoxide) adsorbing area in the ventilation path;

wherein the ozone decomposing area and the CO adsorbing area are formed in a common oxidizing reaction area in which the carbon monoxide is oxidized by using an active oxygen generated through the ozone decomposition in the oxidizing, reaction area.

In a further aspect of the present invention, there is also provided an apparatus for oxidizing carbon monoxide in an air flowing in a structure forming a path, comprising:

an ozone generating member disposed in the path for generating an ozone for deodorizing an odor component in the air;

an ozone decomposing member disposed in the path for decomposing the ozone for generating an active oxygen; and

a CO (carbon monoxide) adsorbing member disposed in the path for adsorbing and carrying carbon monoxide generated through an incomplete combustion;

wherein the ozone decomposing member and the CO adsorbing member are disposed in a common oxidizing reaction area so as to oxidize the carbon monoxide by the active oxygen.

In a preferred embodiment of this aspect, the ozone generating member may comprise at least one of a discharge photocatalyst module, an ultraviolet lamp device, a corona discharge device and a creeping discharge device, which is disposed on an upstream side of the ozone decomposing member and the CO adsorbing member in the air flow path.

The ozone decomposing member and the CO adsorbing member may be formed as a porous member having a honeycomb structure or a three dimensional mesh structure, and a CO adsorbing area formed by the CO adsorbing member is provided in an ozone decomposing area formed by the ozone decomposing member so as to provide a common CO oxidizing reaction area. The porous member may be composed of at least one kind of a compound selected from the group consisting of alumina, silica, magnesia, silicon carbonate, and aluminum titanate, formed in a honeycomb structure or a three dimensional mesh structure, and the ozone decomposing member and the CO adsorbing member provided to the porous member so as to carry out an oxidizing reaction of the carbon monoxide. The porous member may be made of at least one ozone decomposing substance selected from the group consisting of an oxide of Mn, Cu, or Ni, a porous carbon containing Ni, Co, Mn, or Cu, a zeolite and a clay mineral so as to provide a honeycomb structure or a three dimensional mesh structure to which fine particles constituting the CO adsorbing member are carried.

The CO adsorbing member may be composed of fine particles of at least one platinum based precious metal selected from the group consisting of platinum, iridium, osmium, palladium, rhodium, and ruthenium, and the fine particles are carried by an ozone decomposing substance constituting the ozone decomposing member so as to provide a common CO oxidizing reaction area. Each of the platinum based precious metal fine particles has a particle size of 10 Å to 1,000 Å.

The oxidizing apparatus may further comprise a pre-filter disposed on the air suction port side in the air flow path for removing coarse particles in the air and at least one blower disposed on a downstream side of the pre-filter in the air flow path. An electric dust collector may be further disposed on a downstream side of the pre-filter in the air flow path for removing fine coarse particles in the air.

According to the method and apparatus for oxidizing carbon monoxide of the present invention, the odor component in the air can be substantially removed effectively by the ozone generated by the ozone generating member. The ozone decomposing member and the CO adsorbing member are provided in the common CO oxidizing reaction area so as to actively carry out the oxidizing reaction of the carbon monoxide in the air so as to reduce the CO concentration or eliminate the CO amount.

Furthermore, according to the carbon monoxide oxidizing method and apparatus of the present invention, since there is no need for disposing any member or element for the oxidizing reaction of the carbon monoxide, a troublesome work required therefor can be also eliminated, thus ensuring a long life for use.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is a view for explaining principle of a method and an apparatus for oxidizing carbon monoxide according to a first embodiment of the present invention;

FIG. 2 is an illustrated view explaining a discharge photocatalyst module as an ozone generator provided for the apparatus for oxidizing carbon monoxide according to the first embodiment of the present invention;

FIG. 3 is an illustrated view of a model showing a principle of a CO oxidizing reaction in the apparatus for oxidizing carbon monoxide according to the present invention;

FIG. 4 is a graph showing effect of the CO oxidizing reaction by the apparatus for oxidizing carbon monoxide according to the present invention; and

FIG. 5 is a view for explaining principle of a method and apparatus for oxidizing carbon monoxide according to a second embodiment of the present invention.

### DESCRIPTION OF THE PREFERRED EMBODIMENTS

Preferred embodiments of a method and an apparatus for oxidizing carbon monoxide according to the present invention will be described hereunder with reference to the accompanied drawings.

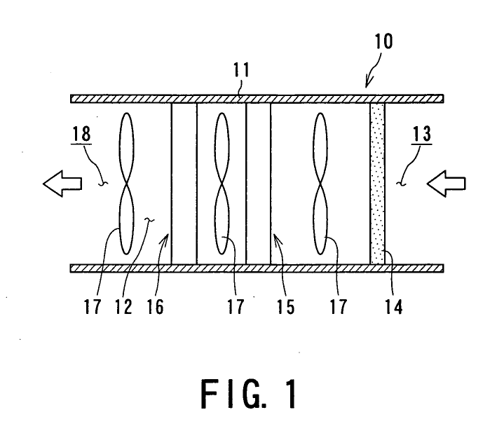

With reference to FIG. 1, showing the first embodiment of the oxidizing apparatus for oxidizing carbon monoxide, the oxidizing apparatus 10 for oxidizing carbon monoxide is generally provided for an air cleaner, a smoke separator, a deodorizing equipment (deodorizer), an air conditioner, an air cleaning/deodorizing system, or the like, or utilized as air cleaner, smoke separator, deodorizer, or air cleaning/deodorizing system itself. This oxidizing apparatus 10 for carbon monoxide is an apparatus for deodorizing an odor component in the air and oxidizing carbon monoxide (CO) generated through incomplete combustion at an ordinary temperature so as to reduce or eliminate the concentration thereof.

The oxidizing apparatus 10 for carbon monoxide of this embodiment comprises a cylindrical casing 11 as a main body, a ventilation path 12 for ventilating the air provided in the casing 11. In the ventilation path 12, a pre-filter 14 for removing foreign substances such as dust or coarse particles in the air, an ozone generating means (ozone generator or ozone generating member) 15 for generating ozone (O₃), and a CO oxidizing member (CO oxidizing member or device) 16 for oxidizing carbon monoxide (CO) at an ordinary temperature are provided successively in this order from a side of an air inlet port (air suction port) 13. Further, one or more (at least one) blower 17 are disposed at optional positions on the ventilation path 12 of the cylindrical casing 11. The carbon monoxide in the air is thus oxidized by the CO oxidizing member 16 at an ordinary temperature to thereby generate carbon dioxide (CO₂), and thereafter, the generated CO₂ is discharged from an air outlet (air discharge port) 18 to the outside of the casing 11.

The ozone generator 15 is composed of a discharge-type photocatalyst module, an ultraviolet lamp device, a corona discharge device, a creeping discharge device, and an X-ray generator, or combination of at least two of them and creates an ozone generating area A in the ventilation path 12 so that the air can be purified and deodorized in the ozone generating area A. The ozone functions to execute the corona discharge or the creeping discharge in the air, and the ozone is generated by irradiating an ultraviolet ray, an X-ray, or a cathode ray, and achieves strong disinfecting, bleaching and oxidizing functions.

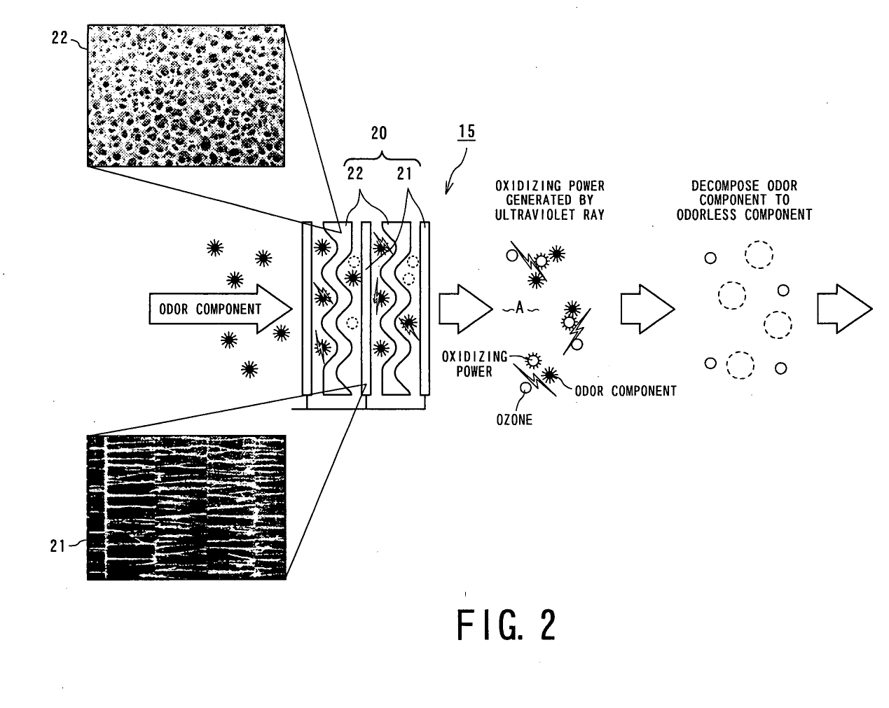

As the ozone generator 15, a discharge photocatalyst module 20 shown in FIG. 2 may be used. This discharge photocatalyst module 20 is provided with a porous ceramics 22 carrying the photocatalyst at a portion between electric discharge electrodes 21. The porous ceramics 22 comprises a photocatalyst carrier for carrying the photocatalyst, and the ultraviolet ray generated by the electric discharge is directly utilized for exciting the photocatalyst. Such porous ceramics 22 also acts to carry out a filtering function.

Through such irradiation of the ultraviolet ray to the photocatalyst, a disinfecting function by the generated ozone, an oxidizing function and a decomposing function of the photocatalyst by the activating carbon are attained or facilitated, and as a result, the air can be effectively purified and deodorized. The odor component can be decomposed by the electric discharge effect, the ozone generation effect and the photocatalyst applying effect by about 10 times, in decomposing performance, in comparison with decomposing effect by a conventional lamp type photocatalyst module.

When such discharge photocatalyst module 20 is employed for the ozone generator 15, the light emission by the electric discharge can be utilized as a light source so that constitutional elements or like such as an active carbon and a lamp, which are required to be exchanged in a long use, can be eliminated, thus realizing a long usable life time.

Furthermore, by reforming or modifying the surface area of the photocatalyst so as to provide a photocatalyst module having a large specific surface area, the photocatalyst decomposing function can be promoted and the air purifying function and the air deodorizing function can be improved.

The ozone (O₃) generated by the ozone generator 15 is subjected to the air purifying and deodorizing processes in the ozone generating area A and is blown by the blower 17 towards the CO oxidizing member 16.

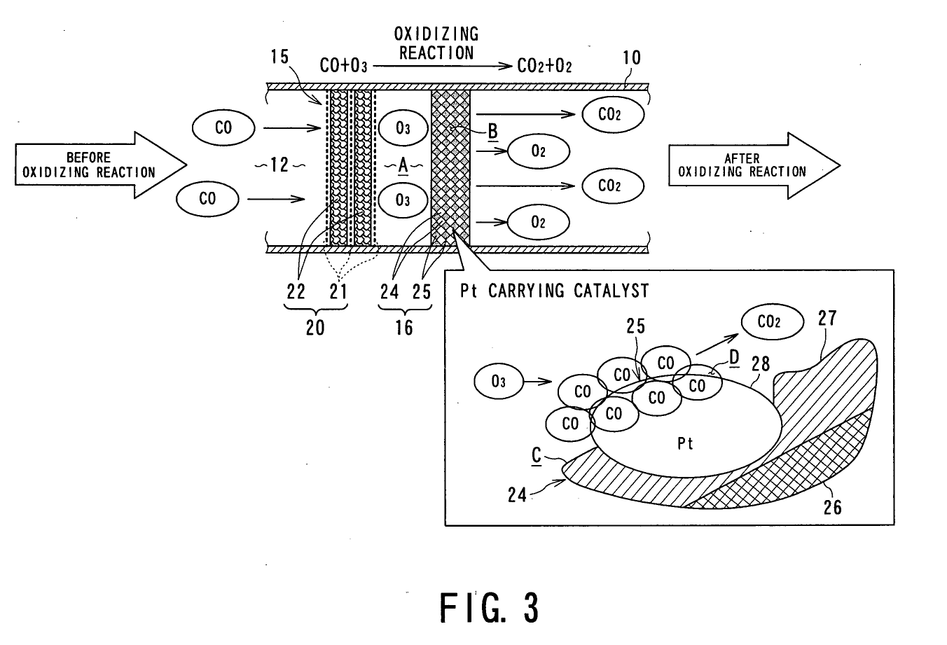

As shown in FIG. 3, the CO oxidizing member 16 comprises an ozone decomposer (decomposing element) 24 for decomposing the generated ozone and then generating an active oxygen (radical oxygen), and a CO adsorber (adsorbing element) 25 for adsorbing the carbon monoxide (CO) generated through the incomplete combustion, which constitute an oxidizing reaction area B for carbon monoxide. The ozone decomposer 24 and the CO adsorber 25 are provided in the common CO oxidizing reaction area B so as to carry out the oxidizing reaction of the carbon monoxide (CO) by using the active oxygen.

The ozone decomposer 24 is made of at least one ozone decomposing substance 27 selected from the group consisting of an oxide of Mn, Cu, or Ni, a porous carbon containing Ni, Co, Mn, or Cu, a zeolite and a clay mineral. The ozone decomposing substance 27 is composed of a waste ozone catalyst and provided for a base member 26 composed of a porous member having a honeycomb structure or a three dimensional mesh structure (sponge structure) by means of coating, welding or like.

The base member 26 provided with the ozone decomposing substance 27 is composed of at least one kind of a compound selected from the group consisting of alumina, silica, magnesium, silicon carbonate, and aluminum titanate, which is formed as a porous member having a honeycomb structure or a three dimensional mesh structure.

Moreover, instead of providing the ozone decomposing substance 27 in the base member 26, the ozone decomposing substance 27 may be formed itself as a porous member having a honeycomb structure or a three dimensional mesh structure. In this case, since the ozone decomposing means 24 also attains a function as a carrier, so that the base member can be eliminated.

On the other hand, the CO adsorber 25 constituting the ozone generator 15 is composed of fine particles 28 of at least one platinum based VIII group precious metal selected from the group consisting of platinum, iridium, osmium, palladium, rhodium, and ruthenium.

The platinum based precious metal fine particles 28 each has a particle size of 10 Å to 1,000 Å, preferably a particle size of 50 Å to 400 Å. The fine particles 28 are carried on the ozone decomposing substance 27 as a waste ozone catalyst constituting the CO adsorber 25 as shown in FIG. 3. That is, a large number of such platinum based precious metal fine particles, such as the platinum fine particles 28, are carried densely on the ozone decomposing substance 27 as the waste ozone catalyst so as to form a common CO oxidizing reaction layer or a reaction surface. In the case of using the platinum (Pt) fine particles 28 for the CO adsorber 25, the ozone decomposing substance 27 constitutes a platinum carrying catalyst.

The ozone decomposing substance 27 constituting the ozone decomposer 24 decomposes the ozone (O₃) so as to generate the active oxygen (radical oxygen: 0), which has a life time of a 10⁻⁶ to 10⁻⁷ sec order, being extremely short. In order to oxidize the carbon monoxide (CO) by the active oxygen, it is therefore necessary to densely capture the carbon monoxide in an effective reaction distance as the effective life of the active oxygen.

That is, it is necessary for the active oxygen (oxygen atom O) to be contacted and reacted with the carbon monoxide molecule during the process from its generation to annihilation, and through this contact, the oxidizing reaction can be generated at an ordinary temperature. For this reason, it becomes necessary to densely capture a large number of carbon monoxide molecules in the extreme vicinity of the active oxygen generating area through the ozone decomposition.

In the oxidizing apparatus 10 for oxidizing the carbon monoxide, a CO adsorbing area D for adsorbing the carbon monoxide (CO) is formed in the ozone decomposing area C composed of the ozone decomposer 24. The CO adsorbing area D is a mesh like area composed of the CO adsorber 25 of the fine particle structure.

With reference to FIG. 3, the ozone decomposing area C of the ozone decomposer 24 and the CO adsorbing area D of the CO adsorber 25 are commonly formed in the CO oxidizing reaction area B, so that the carbon monoxide generated and captured through the incomplete combustion contacts the active oxygen and easily carry out the oxidizing reaction at an ordinary temperature. Although the carbon monoxide is physiologically extremely poisonous and it couples with hemoglobin in the blood to thereby paralyze or deteriorate its function, its poisoning or toxicity can be removed by oxidizing the carbon monoxide to the carbon dioxide.

The function or operation of the oxidizing apparatus 10 for oxidizing carbon monoxide of the structures mentioned above will be explained hereunder.

The oxidizing apparatus 10 can oxidize the carbon monoxide generated in the incomplete combustion at an ordinary temperature so as to eliminate the carbon monoxide or remarkably reduce the concentration thereof. In addition, it is applicable for deodorizing an interior of a vehicle such as passenger car or a taxi as an air purifying (cleaning) and deodorizing device; deodorizing the disinfection odor in a hospital or a residential care institution or like; deodorizing a car refrigerator, a domestic refrigerator, a truck cargo room or the like; deodorizing a toilet and a raw garbage odor; and so on.

In the oxidizing apparatus 10, the coarse particles such as dusts and dirt flown into the ventilation path 12 of the casing 11 can be removed by the pre-filter 14 arranged therein. The air after the removal of the coarse particles is forcibly blown and guided in the ventilation path 12 by the blower 17 towards the ozone generator 15.

In the ozone generator 15, the ozone is generated through the corona discharge, the creeping discharge or the ultraviolet ray irradiation process to thereby remove, eliminate or disinfect the odor component in the air through the reaction with the generated ozone.

As shown in FIGS. 2 and 3, in the case that the ozone generator 15 is composed of the discharge photocatalyst module 20, the odor component in the air can be decomposed into an odorless component by the disinfecting function due to the ultraviolet ray, the oxidizing function of the generated ozone, the disinfecting function, and the decomposition due to the photocatalyst.

For example, in a smoking room, a combustion gas from cigarette includes, in addition to the CO₂, carbon monoxide or ammonium by the incomplete combustion, alcohols and aldehydes. Furthermore, there may be listed up formaldehyde contained in construction material for buildings, ammonium contained in raw garbage odor or food odor, hydrogen sulfide, trimethyl amine, ammonium, acetic acid, acetaldehyde, formaldehyde, trimethyl amine contained in a vehicle interior air, or like.

The odor components in the air, such as ammonium, hydrogen sulfide, trimethyl amine, methyl dioxide, acetaldehyde, formaldehyde, styrene, or like can be decomposed and removed as odorless air while passing through the ozone generating area A in the cylindrical casing 11 of the oxidizing apparatus 10. However, the CO gas as incomplete combustion gas passes through the ozone generating area A as it is and is guided to the CO oxidizing area B.

The air from which the odor component is removed is guided to the CO oxidizing member or element 16 consisting the CO oxidizing area B together with the carbon monoxide. The CO oxidizing member 16 is provided, in the CO oxidizing reaction area B, with the ozone decomposer 24 and the CO adsorber 25 so as to carry out the oxidizing reaction to the carbon monoxide. The CO adsorbing area D composed of the CO adsorber 25 is provided in the ozone decomposing area C constituting the ozone decomposer 24. The ozone decomposing area C and the CO adsorbing area D thus form the common CO oxidizing reaction area B.

In the CO oxidizing member 16, the CO adsorbing area D, in which the fine particles 28 for adsorbing the carbon monoxide (CO) are densely distributed, is provided in the vicinity of the ozone decomposing area C for generating the active oxygen (radical oxygen) by decomposing the ozone (O₃). The CO adsorber 25 provided for the CO adsorbing area D is composed of the platinum based precious metal fine particles 28, which are carried on the ozone decomposing layer of the ozone decomposing substance 27 formed to the porous member or on the surface of the porous member in a densely distributed state. Therefore, the surface area of the platinum based precious metal fine particles 28 for adsorbing the carbon monoxide can be made larger, and as a result, the CO carrying area (CO adsorbing area) can be made larger.

Accordingly, the CO adsorbing area D having a large CO carrying area for adsorbing the carbon monoxide (CO) particles can be disposed in the extreme vicinity of the portion or area at which the ozone is generated through the operation of the ozone decomposer 24. Furthermore, the CO adsorber 25 forming the CO adsorbing area D has a large CO carrying area so that the carbon monoxide particles in the air can be effectively captured densely. On the other hand, the CO adsorber 25 carrying a large number of platinum based precious metal fine particles 28 is positioned so that the ozone decomposing layer of the ozone decomposing substance 27 is formed in the vicinity of the fine particles so as to form the common oxidizing reaction layer.

Since the CO oxidizing member 16 is provided, in its ozone decomposing area C, with the CO adsorbing area D in which a large number of fine particles 28 are distributed, the active oxygen generated by the ozone decomposer 24 can easily contact the carbon monoxide in the high concentration distribution in the vicinity thereof so as to facilitate the oxidizing reaction. Therefore, in the CO oxidizing element 16, the active oxygen generated by the ozone decomposer 24 can contact the highly concentrated carbon monoxide captured by the CO adsorber 25 to thereby easily facilitate the oxidizing reaction.

As mentioned above, the oxidizing reaction can be promoted only by capturing the carbon monoxide in the extreme vicinity of the active oxygen generating area at which the active ozone is generated by the ozone decomposer 24. That is, it is confirmed for the first time that the carbon monoxide can be oxidized easily by capturing the carbon monoxide at a high concentration in the vicinity of the active oxygen generating portion.

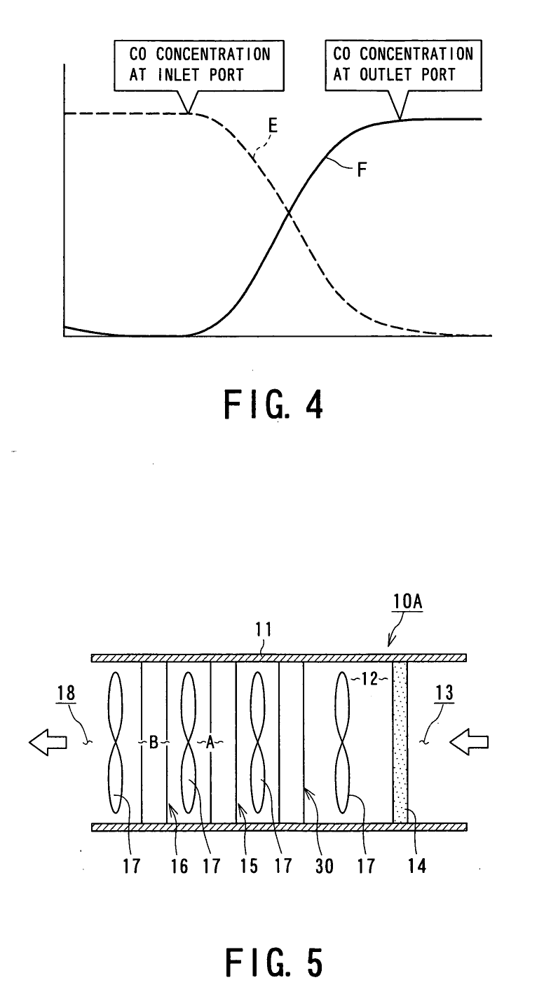

With reference to FIG. 4, in the use of the carbon monoxide oxidizing apparatus 10 of the characters mentioned above, the carbon monoxide can be subjected to the oxidizing reaction by the active oxygen at an ordinary temperature by passing the air through the ozone generating area A and the CO oxidizing reaction area B of the ventilation path 12, and moreover, the concentration of the carbon monoxide contained in the air discharged from the air outlet 18 of the ventilation path 12 can be made substantially zero as shown by the concentration curve E in FIG. 4. Furthermore, as represented by the concentration curve F in FIG. 4, the carbon dioxide concentration increase through the carbon monoxide oxidizing reaction. The carbon monoxide concentration and the carbon dioxide concentration will be measured by a CO gas concentration meter and a CO₂ gas concentration meter, respectively.

As is apparent from FIG. 4, according to the oxidizing apparatus 10 of the present invention, the carbon monoxide can be oxidized efficiently and effectively at an ordinary temperature so as to produce carbon dioxide. Accordingly, the carbon monoxide concentration can be reduced or made substantially zero by oxidizing the carbon monoxide.

Even in the case that the ozone is decomposed by the ozone decomposer 24 of the CO oxidizing member 16 to thereby generate the active oxygen, since the life of the active oxygen is extremely short, the active oxygen can be surely prevented from being discharged externally through the air outlet 18.

FIG. 5 is a diagram showing a principal of the second embodiment of an oxidizing apparatus 10A for oxidizing carbon monoxide according to the present invention.

This carbon monoxide oxidizing apparatus 10A differs from the oxidizing apparatus 10 shown in FIG. 1 in its basic structure. That is, in this oxidizing apparatus 10A of the second embodiment, an electric dust collector 30 is arranged in the downstream side of the pre-filter 14 in the ventilation path 12. The electric dust collector 30 is disposed for the purpose of removing more fine dust or like which cannot be removed by the pre-filter 14.

Further, the other configuration and function are substantially the same as those of the first embodiment, so that the detail explanations thereof are omitted herein.

It is to be noted that the present invention is not limited to the described embodiments and many other changes and modifications may be made without departing from the scopes of the appended claims.

What is claimed is:

1. A method of oxidizing carbon monoxide in an air flowing in a structure forming a path comprising the steps of:
generating ozone for deodorizing an odor component in the air in an ozone generating area;
decomposing the generated ozone in an ozone decomposing area; and
adsorbing and carrying carbon monoxide generated through an incomplete combustion in a CO (carbon monoxide) adsorbing area;
wherein the ozone decomposing area and the CO adsorbing area are formed in a common oxidizing reaction area in which the carbon monoxide is oxidized by using active oxygen generated through the ozone decomposing step in the oxidizing reaction area.

2. A method of oxidizing carbon monoxide according to claim 1, wherein the ozone is generated, by a discharge type photocatalyst module, in the ozone generating area for eliminating the odor component, and the ozone decomposing area for decomposing the ozone is formed in the CO adsorbing area for adsorbing the carbon monoxide.

3. A method of oxidizing carbon monoxide in an air flowing through a ventilation path having a suction port and a discharge port, comprising the steps of:
generating an ozone in an ozone generating area for generating the ozone in the ventilation path;
deodorizing an odor component in the air by the ozone generated in the ozone generating area;
decomposing the generated ozone into active oxygen in an ozone decomposing area disposed on a downstream side of the ozone generating area in the ventilation path; and
adsorbing and carrying carbon monoxide generated through an incomplete combustion in a CO (carbon monoxide) adsorbing area in the ventilation path;
wherein the ozone decomposing area and the CO adsorbing area are formed in a common oxidizing reaction area in which the carbon monoxide is oxidized by using an active oxygen generated through the ozone decomposition in the oxidizing reaction area.

4. An apparatus for oxidizing carbon monoxide in an air flowing in a structure forming a path, comprising:
an ozone generating member disposed in the path for generating an ozone for deodorizing an odor component in the air;
an ozone decomposing member disposed in the path for decomposing the ozone for generating an active oxygen; and
a CO (carbon monoxide) adsorbing member disposed in the path for adsorbing and carrying carbon monoxide generated through an incomplete combustion;
wherein the ozone decomposing member and the CO adsorbing member are disposed in a common oxidizing reaction area so as to oxidize the carbon monoxide by the active oxygen.

5. An apparatus for oxidizing carbon monoxide according to claim 4, wherein the ozone generating member comprises at least one of a discharge type photocatalyst module, an ultraviolet lamp device, a corona discharge device and a creeping discharge device, which is disposed on an upstream side of the ozone decomposing member and the CO adsorbing member in the air flow path.

6. An apparatus for oxidizing carbon monoxide according to claim 4, the ozone decomposing member and the CO adsorbing member are formed as a porous member having a honeycomb structure or a three dimensional mesh structure, and a CO adsorbing area formed by the CO adsorbing member is provided in an ozone decomposing area formed by the ozone decomposing member so as to provide a common CO oxidizing reaction area.

7. An apparatus for oxidizing carbon monoxide according to claim 6, wherein the porous member is composed of at least one kind of a compound selected from the group consisting of alumina, silica, magnesia, silicon carbonate, and aluminum titanate, formed in a honeycomb structure or a three dimensional mesh structure, and the ozone decomposing member and the CO adsorbing member provided to the porous member so as to carry out an oxidizing reaction of the carbon monoxide.

8. An apparatus for oxidizing carbon monoxide according to claim 6, wherein the porous member is made of at least one ozone decomposing substance selected from the group consisting of an oxide of Mn, Cu, or Ni, a porous carbon containing Ni, Co, Mn, or Cu, a zeolite and a clay mineral so as to provide a honeycomb structure or a three dimensional mesh structure to which fine particles constituting the CO adsorbing member are carried.

9. An apparatus for oxidizing carbon monoxide according to claim 4, wherein the CO adsorbing member is composed of fine particles of at least one platinum based precious metal selected from the group consisting of platinum, iridium, osmium, palladium, rhodium, and ruthenium, and said fine particles are carried by an ozone decomposing substance constituting the ozone decomposing member so as to provide a common CO oxidizing reaction area.

10. An apparatus for oxidizing carbon monoxide according to claim 9, wherein the platinum based precious metal fine particles each has a particle size of 10 Å to 1,000 Å.

11. An apparatus for oxidizing carbon monoxide according to claim 4, further comprising a pre-filter disposed on the air suction port side in the air flow path for removing coarse particles in the air and at least one blower disposed on a downstream side of the pre-filter in the air flow path.

12. An apparatus for oxidizing carbon monoxide according to claim 11, further comprising an electric dust collector disposed on a downstream side of the pre-filter in the air flow path for removing fine coarse particles in the air.
